(19) United States
(12) Patent Application Publication
(10) Pub. No.: US 2022/0316493 A1
(43) Pub. Date: Oct. 6, 2022

(54) COOLING FAN

(71) Applicant: Acer Incorporated, New Taipei CIty (TW)

(72) Inventors: Cheng-Wen Hsieh, New Taipei City (TW); Wen-Neng Liao, New Taipei City (TW); Kuang-Hua Lin, New Taipei City (TW); Wei-Chin Chen, New Taipei City (TW)

(73) Assignee: Acer Incorporated, New Taipei City (TW)

(21) Appl. No.: 17/711,066

(22) Filed: Apr. 1, 2022

(30) Foreign Application Priority Data
Apr. 6, 2021 (TW) 110112454

(51) Int. Cl. F04D 29/38; F04D 19/00; F04D 29/32

(52) U.S. Cl. CPC F04D 29/384; F04D 19/002; F04D 29/325

(57) ABSTRACT

A cooling fan includes a hub, a plurality of blades, and a plurality of flow disturbing elements. The blades are arranged on a peripheral surface of the hub; each of the blades has a leading edge and a trailing edge opposite to the leading edge, and each of the blades has at least one flow disturbing element arranged at the trailing edge. Each of the flow disturbing elements includes an engaging part and an extending part opposite to the engaging part; the engaging part of each of the flow disturbing elements is connected to the trailing edge of the corresponding blade, and the extending part of each of the flow disturbing elements extends outwardly toward a direction away from the trailing edge of the corresponding blade.

### CROSS-REFERENCE TO RELATED APPLICATION

This application claims the priority benefit of Taiwan application serial no. 110112454, filed on Apr. 6, 2021. The entirety of the above-mentioned patent application is hereby incorporated by reference herein and made a part of this specification.

### BACKGROUND

### Technical Field

The disclosure relates to a fan, and more particularly, relates to a cooling fan.

### Description of Related Art

As the computation performance and the quantity of computation of electronic devices increase, the electronic devices may release a significant amount of heat during operation. If the heat cannot be quickly dissipated from the inside of the electronic devices to the outside, it is very much likely to cause system crash, decline in the computation performance and the quantity of computation, or other negative impact. Therefore, common electronic devices are equipped with fans inside to quickly dissipate heat to the outside through active or forced heat dissipation.

Generally, a fan includes a hub and a plurality of blades arranged on a peripheral surface of the hub, wherein the hub is configured to be driven by a motor to rotate, and the blades rotate synchronously with the hub. During the rotation of the fan, an airflow flows from a leading edge of each blade to a trailing edge, and the airflow is likely to become an air eddy at the trailing edge, which is accompanied by noise generation and leads to reduction of the operating efficiency of the fan.

### SUMMARY

The disclosure provides a cooling fan capable of reducing noise generated during operation.

According to an embodiment of the disclosure, a cooling fan that includes a hub, a plurality of blades, and a plurality of flow disturbing elements is provided. The blades are arranged on a peripheral surface of the hub, wherein each blade has a trailing edge of a leading edge and an opposite to leading edge, and each of the blades has at least one of the flow disturbing elements disposed at the trailing edge. Each of the flow disturbing elements includes an engaging part and an extending part opposite to the engaging part, wherein the engaging part of each of the flow disturbing elements is connected to the trailing edge of a corresponding blade of the blades, and the extending part of each of the flow disturbing elements extends outwardly toward a direction away from the trailing edge of the corresponding blade.

In view of the above, the cooling fan provided in one or more embodiments of the disclosure may effectively eliminate air eddies and reduce noise generated during operation.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic view of a cooling fan according to a first embodiment of the disclosure.

FIG. 1B is a schematic top view of the cooling fan according to the first embodiment of the disclosure.

FIG. 1C is a schematic side view of the cooling fan according to the first embodiment of the disclosure.

FIG. 2 is a schematic view of a cooling fan according to a second embodiment of the disclosure.

FIG. 3 is a schematic view of a cooling fan according to a third embodiment of the disclosure.

FIG. 4 is a schematic view of a cooling fan according to a fourth embodiment of the disclosure.

### DESCRIPTION OF THE EMBODIMENTS

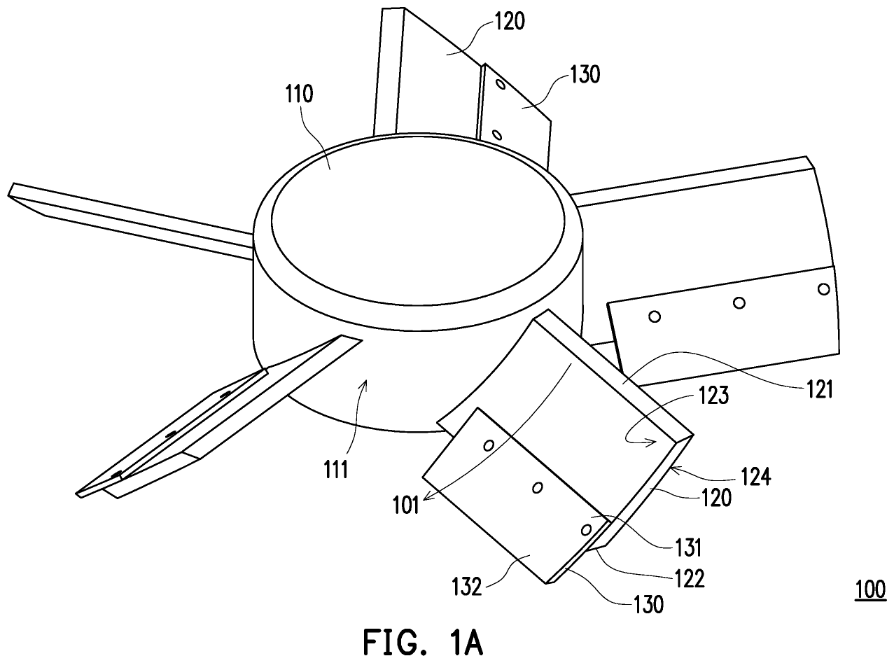

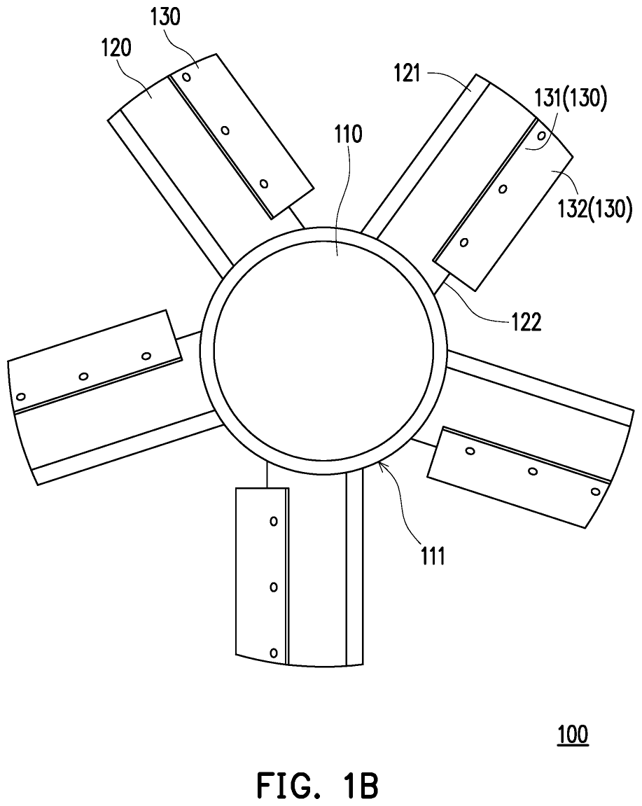

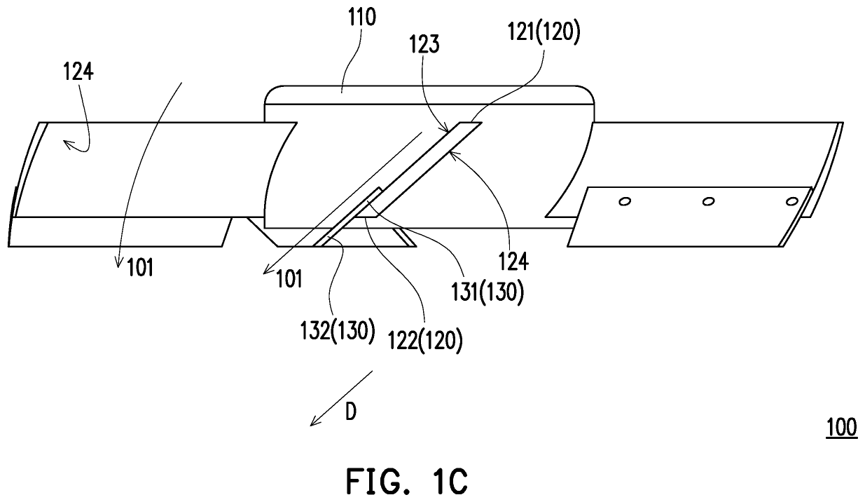

FIG. 1A is a schematic view of a cooling fan according to a first embodiment of the disclosure. FIG. 1B is a schematic top view of the cooling fan according to the first embodiment of the disclosure. FIG. 1C is a schematic side view of the cooling fan according to the first embodiment of the disclosure. With reference to FIG. 1A to FIG. 1C, in this embodiment, a cooling fan 100 may be an axial fan and is adapted to a computer host, a server, a notebook computer, or other electronic devices. The cooling fan 100 includes a hub 110, a plurality of blades 120, and a plurality of flow disturbing elements 130, wherein the hub 110 serves as a rotation reference of the cooling fan 100, and the hub 110 is configured to be driven by a motor to rotate. The blades 120 are equidistantly disposed on a peripheral surface 111 of the hub 110, and each of the blades 120 has a leading edge 121 and a trailing edge 122 opposite to the leading edge 121. For instance, the hub 110 and the blades 120 may be made by injection molding and may be integrally formed, and a material of the hub 110 and the blades 120 may be plastic.

During rotation of the hub 110, the blades 120 rotate synchronously with the hub 110, which generates an airflow 101. The airflow 101 flows from the leading edge 121 of each blade 120 to the trailing edge 122. In order to eliminate air eddies which are likely to be produced on the trailing edge 122, each blade 120 has at least one flow disturbing element 130 disposed at the trailing edge 122. In this embodiment, each blade 120 has one flow disturbing element 130 disposed at the trailing edge 122, and each flow disturbing element 130 and the peripheral surface 111 of the hub 110 are spaced from each other.

For instance, a material of the flow disturbing elements 130 may be metal or alloy, and the flow disturbing elements 130 may have a fin-shaped structure and may be made of aluminum or stainless steel, so as to have good elasticity. When the cooling fan 100 is operating, each flow disturbing element 130 affected by the airflow 101 produces elastic deformation (such as a swing action) to disturb the airflow 101 flowing to the trailing edge 122 of the corresponding blade 120, whereby the air eddies may be eliminated and noise generated during operation may be reduced. In addition, since the flow disturbing elements 130 may effectively eliminate the air eddies, the cooling fan 100 may not only have good operating efficiency but also reduce energy loss.

As shown in FIG. 1A to FIG. 1C, in this embodiment, each flow disturbing element 130 includes an engaging part 131 and an extending part 132 opposite to engaging part 131, wherein the engaging part 131 of each flow disturbing element 130 is connected to the trailing edge 122 of the corresponding blade 120, and the extending part 132 of each flow disturbing element 130 extends outwardly toward a direction D away from the trailing edge 122 of the corresponding blade 120. Furthermore, each blade 120 also has a positive pressure surface 123 and a negative pressure surface 124 opposite to the positive pressure surface 123, and the positive pressure surface 123 and the negative pressure surface 124 are located between the leading edge 121 and the trailing edge 122.

To be specific, the positive pressure surface 123 of each blade 120 extends from the leading edge 121 to the trailing edge 122, and the negative pressure surface 124 of each blade 120 extends from the leading edge 121 to the trailing edge 122. On the other hand, the positive pressure surface 123 of each blade 120 faces an air inlet side of the cooling fan 100, and the negative pressure surface 124 of each blade 120 faces an air outlet side of the cooling fan 100.

The engaging part 131 of each flow disturbing element 130 is engaged and overlapped with the positive pressure surface 123 of the corresponding blade 120 and approaches the trailing edge 122. The extending part 132 of each flow disturbing element 130 is not overlapped with the positive pressure surface 123 of the corresponding blade 120 and extends outwardly toward the direction D away from the trailing edge 122 of the corresponding blade 120. When the cooling fan 100 is operating, the extending part 132 of each flow disturbing element 130 affected by the airflow 101 produces elastic deformation (such as a swing action) to disturb the airflow 101 flowing to the trailing edge 122 of the corresponding blade 120, whereby the air eddies may be eliminated.

For instance, the engaging part 131 of each flow disturbing element 130 may be connected to the positive pressure surface 123 of the corresponding blade 120 by riveting, locking, latching, welding, or adhesion.

In other embodiments, each flow disturbing element may be equipped with a groove formed in the extending part through performing a stamping process; as such, the airflow flowing to the extending part on the positive pressure surface of the corresponding blade may flow through the groove to the negative pressure surface of the corresponding blade, so as to be converged to the airflow flowing through the negative pressure surface of the corresponding blade.

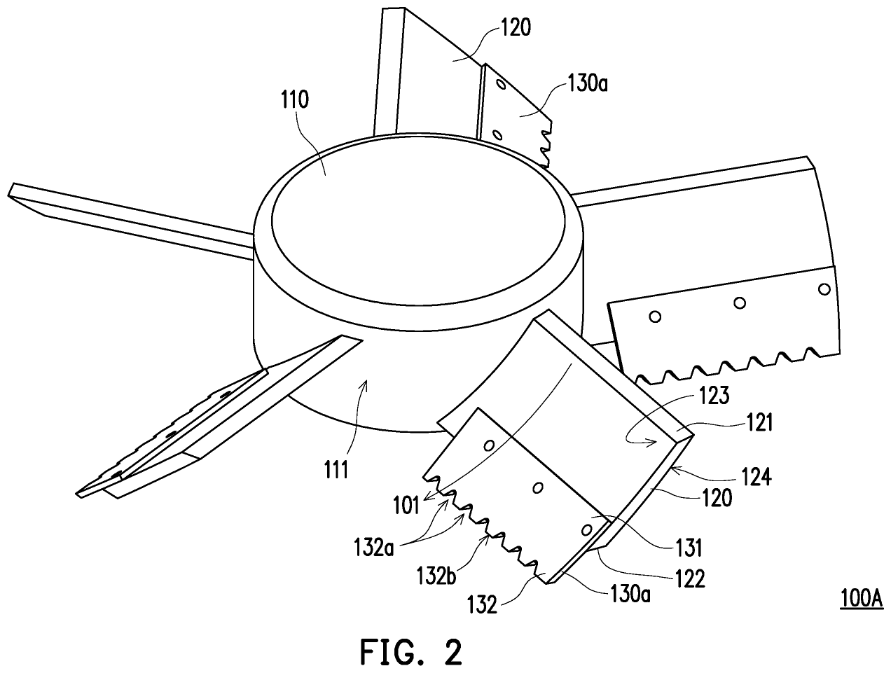

FIG. 2 is a schematic view of a cooling fan according to a second embodiment of the disclosure. With reference to FIG. 2, the design principle of the cooling fan 100A provided in this embodiment is substantially the same as the design principle of the cooling fan 100 provided in the first embodiment, while the main difference lies in that each flow disturbing element 130a in this embodiment has a plurality of recesses 132a arranged at a distal edge 132b of the extending part 132 away from the trailing edge 122. When the cooling fan 100A is operating, the recesses 132a of each flow disturbing element 130a may disturb the airflow 101 flowing to the distal edge 132b of the extending part 132, thereby eliminating the air eddies.

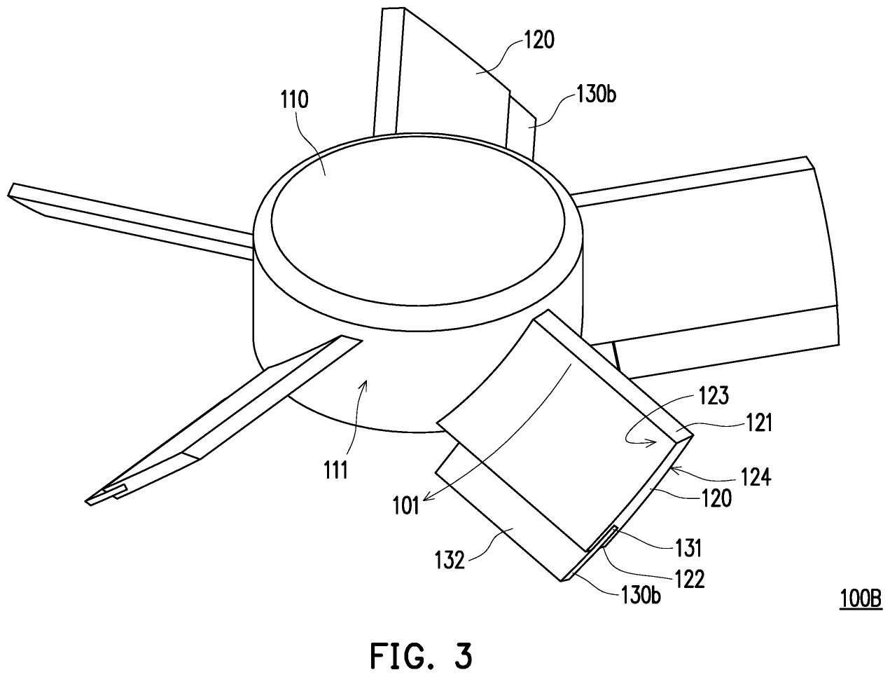

FIG. 3 is a schematic view of a cooling fan according to a third embodiment of the disclosure. With reference to FIG. 3, the design principle of the cooling fan 100B provided in this embodiment is substantially the same as the design principle of the cooling fan 100 provided in the first embodiment, while the main difference lies in that the engaging part 131 of each of the flow disturbing elements 130b in this embodiment is embedded in the corresponding blade 120 and is located between the positive pressure surface 123 and the negative pressure surface 124. For instance, the flow disturbing elements 130b may be embedded into the blades 120 by insert molding.

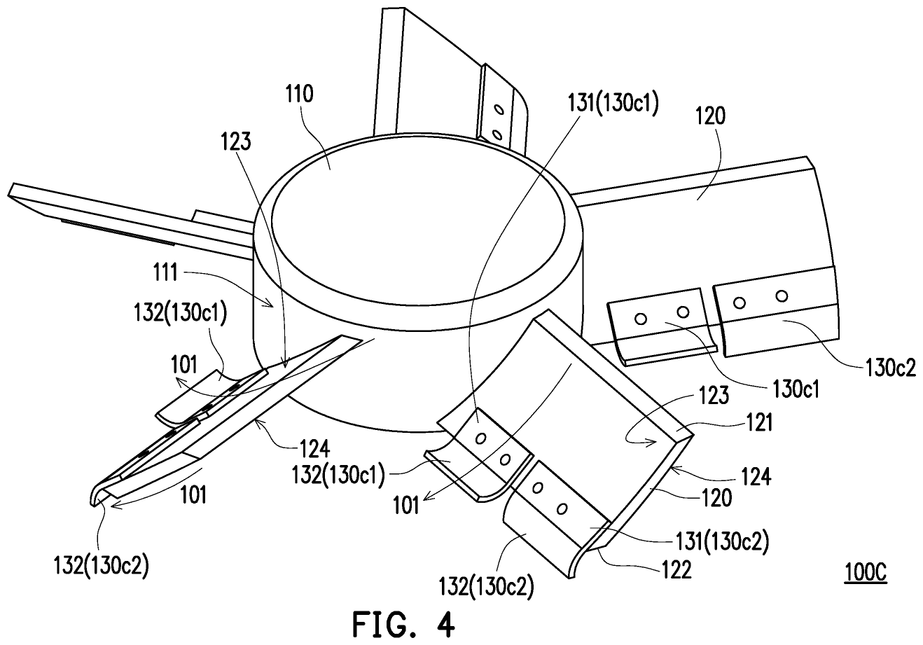

FIG. 4 is a schematic view of a cooling fan according to a fourth embodiment of the disclosure. With reference to FIG. 4, the design principle of the cooling fan 100C provided in this embodiment is substantially the same as the design principle of the cooling fan 100 provided in the first embodiment, while the main difference lies in that each of the blades 120 in this embodiment has a first flow disturbing element 130c1 and a second flow disturbing element 130c2 disposed at the trailing edge 122, wherein the first flow disturbing element 130c1 and the second flow disturbing element 130c2 are juxtaposed and spaced from each other.

On each of the blades 120, the first flow disturbing element 130c1 is closer to the peripheral surface 111 of the hub 110 than the second flow disturbing element 130c2; that is, the first flow disturbing element 130c1 is located between the peripheral surface 111 of the hub 110 and the second flow disturbing element 130c2. Furthermore, the extending part 132 of the first flow disturbing element 130c1 and the extending part 132 of the second flow disturbing element 130c2 are both bent, and a bending direction of the extending part 132 of the first flow disturbing element 130c1 is opposite to a bending direction of the extending part 132 of the second flow disturbing element 130c2. To be specific, the extending part 132 of the first flow disturbing element 130c1 bends toward an air inlet side of the cooling fan 100C to disturb an airflow 101 flowing through the positive pressure surface 123. In addition, the extending part 132 of the second flow disturbing element 130c2 is bent toward an air outlet side of the cooling fan 100C to disturb the airflow 101 flowing through the negative pressure surface 124.

To sum up, in the cooling fan provided in one or more embodiments of the disclosure, the blades have the flow disturbing elements disposed at the trailing edges. When the cooling fan is operating, the flow disturbing elements affected by the airflows produce elastic deformation (such as a swing action), whereby air eddies may be eliminated and noise generated during operation may be reduced. In addition, since the flow disturbing elements may effectively eliminate air eddies, the cooling fan may not only have good operating efficiency but also reduce energy loss.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A cooling fan, comprising:
a hub;
a plurality of blades, arranged on a peripheral surface of the hub, each of the blades having a leading edge and a trailing edge opposite to the leading edge; and
a plurality of flow disturbing elements, wherein each of the blades has at least one of the flow disturbing elements disposed at the trailing edge, each of the flow disturbing elements comprises an engaging part and an extending part opposite to the engaging part, the engaging part of each of the flow disturbing elements is connected to the trailing edge of a corresponding blade of the blades, and the extending part of each of the flow disturbing elements extends outwardly toward a direction away from the trailing edge of the corresponding blade.

2. The cooling fan according to claim 1, wherein each of the blades also has a positive pressure surface and a negative pressure surface opposite to the positive pressure surface, and the positive pressure surface and the negative pressure surface are located between the leading edge and the trailing edge.

3. The cooling fan according to claim 2, wherein the engaging part of each of the flow disturbing elements is connected to the positive pressure surface of the corresponding blade.

4. The cooling fan according to claim 2, wherein the engaging part of each of the flow disturbing elements is embedded in the corresponding blade and is located between the positive pressure surface and the negative pressure surface.

5. The cooling fan according to claim 2, wherein each of the blades has two of the flow disturbing elements disposed at the trailing edge, and the two flow disturbing elements are connected to the positive pressure surface of the blade.

6. The cooling fan according to claim 5, wherein in each of the blades, one of the two flow disturbing elements disposed at the trailing edge is located between the hub and the other of the two flow disturbing elements.

7. The cooling fan according to claim 5, wherein in each of the blades, the extending part of one of the two flow disturbing elements and the extending part of the other of the two flow disturbing elements are bent, and bending directions of the two extending parts of the two flow disturbing elements are opposite to each other.

8. The cooling fan according to claim 1, wherein each of the flow disturbing elements has a plurality of recesses, and the recesses are arranged at a distal edge of the extending part away from the trailing edge.

9. The cooling fan according to claim 1, wherein a material of the hub and the blades comprises plastic, and the flow disturbing elements comprise metal or alloy.
